(19) United States
(12) Patent Application Publication
(10) Pub. No.: US 2004/0018950 A1
(43) Pub. Date: Jan. 29, 2004

(54) Cleaning composition comprising suspended beads

(75) Inventors: Peter Robert Foley, Cincinnati, OH (US); Howard David Hutton, Oregonia, OH (US); Baptiste Pommiers, Etterbeek (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/441,340

(22) Filed: May 20, 2003

Related U.S. Application Data
(60) Provisional application No. 60/382,277, filed on May 21, 2002.

(51) Int. Cl. C11D 1/00

(52) U.S. Cl. 510/218; 510/235

(57) ABSTRACT

The present application relates to a composition, suitable for use as a manual dishwashing composition, comprising stably suspended beads and at least 20% surfactant, and exhibiting dissolution in water in less than 10 rotations according to the cylinder test described herein.

### CROSS REFERENCE TO RELATED APPLICATION

This application claims the benefit of U.S. Provisional Application No. 60/382277, filed on May 21, 2002, the disclosure of which is incorporated by reference.

### TECHNICAL FIELD

The present invention relates to a composition suitable for use in manual dishwashing comprising high levels of surfactant and suspended beads. The composition has sufficient viscosity to keep the beads stably suspended over time, but yet is pourable and dissolves quickly in water during the dishwashing process.

### BACKGROUND OF THE INVENTION

It has long been desirable to be able to prepare liquid compositions comprising incompatible ingredients. The problem to be over come however is finding a method by which the incompatible ingredients can be kept separate and thus stable before use. One solution to this problem is to formulate the composition such that the incompatible ingredients are in different phases of the composition. For example by preparing one incompatible ingredient in solid form, like a bead, prill or capsule. From a consumer acceptance standpoint, it is essential that such beads are stably suspended through out the composition.

Methods of suspending particulates in a liquid composition are known in the art. One way of suspending particles is to “structure” the liquid. Structured liquids may be broadly characterised in that they comprise high levels of electrolyte (e.g. surfactant) and in that the liquids form ‘micelles’ or ‘lamellar layers’ discussed in greater detail in U.S. Pat. No. 5,147,576 to Montague et al. Liquids prepared in this way are however difficult to pour and owing to the existence of the lamellar layers, are often opaque.

Another method of suspending particles in a liquid composition is the use of thickening agents such as polymers or gums. Thickening gums such as xanthan gum or rhamsan gum provide good viscosity but are liable to thicken the composition to such an extent that the composition becomes difficult to pour (greater than 2500 cps). Further more such gums are susceptible to the presence of electrolytes, such as surfactants, in the composition and thus the level of surfactant in such compositions must be low (less than about 10% by weight do the composition). However low level of electrolyte, especially surfactant in a cleaning composition negatively impacts the performance of the composition to the point where the composition no longer adequately performs as a detergent. Thickening polymers such as acrylate-containing polymers are compatible with surfactants, but provide inadequate viscosity to stably suspend the particulate resulting in the, at least partial, settling of the beads over time.

All of the above methods of suspending beads in liquid compositions rely on increasing the viscosity of the composition. However increasing viscosity has a negative impact on dissolution of the composition in water. While not wanted to be limited by theory, it is believed that the surfactant and/or suspending agents form large structures, micelles or lamellar layers. The formation of such structures reduces or retards the penetration of water and hydration of the system that would then break the structures down. The larger and more hydrophobic the structures the more difficult they are to hydrate and thus dissolve. It has therefore been the object of the present invention to provide a composition that is capable of stably suspended beads, comprises sufficient surfactant to provide adequate cleaning and yet dissolves rapidly in water at temperatures suitable for hand washing.

### SUMMARY OF THE INVENTION

According to the present invention there is provided a composition, suitable for use as a manual dishwashing composition, comprising stably suspended beads at least 20% surfactant, and capable of rapid dissolution measured as described herein.

### DETAILED DESCRIPTION OF THE INVENTION

The composition of the present invention comprises beads. The beads are suspended in a liquid composition which is thickened in order to be able to suspend the beads. The benefit of the present composition is that it is able to stably suspend the beads, but can still dissolve readily on contact with water. By stable it is meant that at least 80% of the beads are still evenly suspended in the composition after a period of storage of 30 days at 21° C.

The composition of the present invention preferably has a viscosity of 100-2000 cps, more preferably a viscosity of 400-1000 cps. The viscosity measurement is taken when the product is neat i.e. undiluted. This is defined as being the 100% composition concentration.

In a preferred embodiment, the composition of the present invention, at 80% composition concentration, has a viscosity of less than the composition at 100% composition concentration. The viscosity measurement is taken after the composition has been diluted by the addition of deionised water. The composition is diluted with deionised water at a ratio of concentrated composition to water of 4:1. This is defined as being the 80% concentrated composition. Measuring the viscosity of the composition when neat and when diluted to a small extent allows the manufacturer to prepare a dilution profile for the composition. A composition, which exhibits a reduction in viscosity after dilution to 80% concentration, will dissolve well in water as opposed to a composition that exhibits an increase in viscosity after equal dilution. Typically compositions of the prior art exhibiting an increase in viscosity at 80% concentrated composition. On further dilution (60%, 40%, 20% concentrated composition) all compositions, including those of the prior art and the present invention, show a decrease in viscosity.

To measure the viscosity of the 100% composition concentration place 100 g of the neat composition in a clean, dry beaker and measure viscosity of the composition using a Brookfield cylinder viscometer, model #VDVII+ with a S-18 spindle at 21° C. at a shear rate of 30 rpm. To measure the viscosity of the 80% composition concentration place 80 g of the composition in a clean, dry beaker and add 20 g of deionised water to dilute the product by a ratio of 4:1. The product is stirred until all composition is visually dissolved. The viscosity of the composition is then measured as above.

As discussed above the rate of dissolution of the composition is affected by the viscosity and the level of surfactant in the composition. It was therefore an object of the present invention to provide compositions that are able to clean well, stably suspend beads, but also dissolve well. The following test procedure is used to measure the dissolution of a composition in water.

The test requires the use of a Suds Cylinder Machine. The machine comprises eight cylinders, each of which may be independently rotated at a rate of 20-22 rpm. Each cylinder measures 12 inches high×4 inches diameter and are marked vertically with inch adhesive measuring tape with gradations showing ⅛ inch markings. The zero of the tape indicates the level of 500 milliliters of solution. Only one side of the machine is used for this test.

The machine rotates 8 cylinders around a fixed central axis at a rate of 22 rpm. It is advisable to use no more than 4 cylinders per test as it is difficult to accurately monitor more cylinders during the test.

Measure out 500 mL of water at 21° C. +/−2° C. into the cylinders required for the test. To each cylinder, slowly pipette 0.6 cc of dyed* test composition into the center of the cylinder. Allow the product to sink to the bottom of the cylinder. Carefully, place the cylinders into the Suds Cylinder Machine ensuring that the cylinders are not shaken and the water/composition is not disrupted. Rotate the cylinders, stop and observe dissolution after each full rotation. A full rotation is understood as meaning that the cylinder are rotated through 360°, being returned to the original stating position at the end of the rotation. Dissolution is said to be achieved when the dyed composition is no longer visible in the water. Record the number of full rotations required to dissolve the composition. According to the present test, compositions that dissolve satisfactorily dissolve in less than 10 rotations of the cylinders. Compositions that dissolve well, dissolve in less than 8 rotations and preferred composition dissolve in less than 6 rotations.

The composition of the present invention has preferably 50% or greater transmittance of light, more preferably 75% or greater, even more preferably 80% or greater transmittance of light using a 1 cm cuvette, at at least one wavelength in the range from 410-800 nanometers (visible light) in the absence of dyes, beads or opacifying agents. Light transmittance is an unitless number defined as the ratio of transmitted light after passing through a sample and the incident light entering a sample. Transmittance was measured using a NovaSpec Spec 20 Spectrophotometer. The compositions described were added to a 1 cm cuvette and inserted into the instrument. % Transmittance was read directly.

The relationship between viscosity, surfactant concentration in the composition, ability to suspend beads and dissolution is supported by the following data comparing compositions of the present invention A, B, C and D (microemulsion); compositions employing unsuitable suspending agents, R and S; and compositions of the prior art, X and Y. The composition formulae are presented in Table 1. The viscosity, bead suspension, pourability and dissolution data of these formulae is presented in Table 2. All compositions comprise 0.1% liposphere (tradename) beads available from Lipotechnologies.

TABLE 1

| | A | B | C | D | R | S | X | Y |
|---|---|---|---|---|---|---|---|---|
| Sodium Alkyl | 26.5 | 26.5 | 26.5 | 26.5 | 26.5 | 26.5 | 29.1 | 28.8 |
| Ethoxy Sulfate | | | | | | | | |
| Alkyl Dimethyl | 6 | 6 | 6 | 5 | 6 | 6 | — | 6 |
| Amine Oxide | | | | | | | | |
| Alkyl | — | — | — | — | — | — | — | 2 |
| Polysaccharide | | | | | | | | |
| Alkyl Amido | — | — | — | — | — | — | 4.8 | — |
| Propyl Betaine | | | | | | | | |
| Alcohol | 2 | 2 | 2 | 2 | 2 | 2 | 2.1 | 4 |
| Ethoxylated | | | | | | | | |
| Nonionic | | | | | | | | |
| Gellan Gum | 0.02 | 0.02 | 0.01 | 0.02 | — | — | — | 0.02 |
| Polyacrylate | — | — | — | — | 2.0 | — | 1 | — |
| Laponite | — | — | — | — | — | 2.0 | — | — |
| Ethanol | 4.5 | 6.0 | 4.5 | — | — | 2.0 | 1.5 | 5.2 |
| Polypropylene | 1 | 1 | 1 | 7 | 4.5 | 5 | — | — |
| Glycol 2000 | | | | | | | | |
| MW | | | | | | | | |
| Sodium | 1 | 1 | 1 | 6 | — | — | — | — |
| Chloride | | | | | | | | |
| Calcium | — | — | — | 1 | 1 | 1 | — | 4.1 |
| Xylene | | | | | | | | |
| Sulfonate | | | | | | | | |
| Sodium | 1.6 | 1.6 | 1.6 | 1 | 1 | 1 | 1.0 | — |
| Cumene | | | | | | | | |
| Sulfonate | | | | | | | | |
| 1.3-Bis | 0.5 | 0.5 | 0.5 | 0.5 | — | — | — | — |
| (aminomethyl) | | | | | | | | |
| cyclohexane | | | | | | | | |
| Beads | 0.1% | 0.1% | 0.1% | 0.1% | 0.1% | 0.1% | 0.1% | 0.1% |

TABLE 2

| | Viscosity | | | |
|---|---|---|---|---|
| | (cps) | Beads stably | Composition | Dissolution |
| Composition | 100% conc. | suspended | Pourable | (rotations) |
| A | 650 | Yes | Yes | 7.5 |
| B | 450 | Yes | Yes | 5.5 |
| C | 400 | Yes | Yes | 5.5 |
| D | 400 | Yes | Yes | 3.5 |
| R | 850 | Yes (hazy) | Yes | >15 |
| S | 680 | No | Yes | 11 |
| X | 2565 | Yes | No | >15 |
| Y | 650 | Yes | Yes | >15 |

Compositions A, B, C and D, representing the present invention, show the acceptable dissolution, stably suspends beads, and are pourable. The compositions of the prior art and those using unsuitable suspending agents all exhibit problems. Composition R, is successful in stably suspending the beads, is pourable but does not dissolve sufficiently well. Composition S, does not stably suspend beads and dissolves poorly. Composition X is so thick it is unpourable and dissolves badly. Composition Y also dissolves badly.

### Beads

The compositions of the present invention comprise beads. Suitable beads for use in such compositions are available in the prior art. The beads may be selected from microcapsules or preferably porous, sponge-like beads. Microcapsule beads comprise a shell surrounding a core. Said core may comprise a void or a separate mass. Porous beads are preferably homogenous and present a sponge-like structure. Either type of bead may serve as a carrier for an ingredient of the composition.

The beads may be of any shape but are preferably three-dimensional. More preferably the beads are substantially rounded, more preferably substantially spherical. The beads of the present invention preferably have an average diameter of from about 100 to about 3,000 microns, preferably from about 500 to about 2000 microns, most preferably from about 750 to about 1250 microns.

The beads of the present invention are preferably dissolvable, crushable, squeezable or ruptureable, such that any active ingredients carried within the beads may be released. Most preferably the beads dissolve on contact with the wash water used in the cleaning process. It is envisaged that the composition comprising the beads can be added to the wash water or added to a cleaning implement for example a sponge or cloth which has or will be moistened with wash water. In this latter situation the beads may dissolve on contact with the water held within the wash implement or may be crushed, squeezed or otherwise ruptured by the mechanical force of the users hand during use of the wash implement.

The present compositions may comprise beads at a wide variation of levels. The beads are typically included in the present compositions at a level of from about 0.001% to about 99.9%, preferably from about 0.005% to about 50%, and more preferably from about 0.01% to about 20%, by weight of the composition.

The beads can be made from a wide variety of materials. Such materials are typically polymeric and are designed to resist becoming solubilized in the chemical matrix of the present compositions. Non-limiting examples of materials suitable for making the beads herein include urea-formaldehydes, melamineformaldehydes, phenolformaldehydes, gelatin, poly(vinyl alcohol), poly(vinyl pyrrolidone), polyacrylates, polyamides, polyurethane, polymethacrylates, polyepoxides, cellulose acetate, cellulose nitrate, cellulose acetate butyrate, ethyl cellulose polyester, polychlorotrifluoroethylene (e.g. KEL-F), ethyl/vinyl acetate, saran, polystyrene, zein, paraffin wax, animal wax, vegetable wax, microcrystalline wax, polyethylene wax, agar, polyoxymethylene urea, methophenols and the like. Preferred bead materials include gelatin, agar, polyoxymethylene urea, methophenols and mixtures thereof. Other suitable bead materials are disclosed in, e.g., U.S. Pat. Nos. 2,800,458; 3,159,585; 3,516,846; 3,533,958; 3,697,437; 3,888,689; 3,996,156; 3,965,033; 4,010,038; 4,016,098; 4,087,376; 5,591,146; UK Patent Nos. 2,006,709 and 2,062,570. Preferred microcapsule beads are available from Lipotechnologies under the tradename lipocapsules. Preferred porous beads are available from Lipotechnologies under the tradename Lipospheres.

The porous, sponge-like beads are preferred over the microcapsule beads as they have been found to be more easily suspended in the compositions of the present invention. This is believed to be due to the fact that the composition can more easily penetrate the bead. The penetration of the composition into the bead has the effect of bringing the density of the bead and the composition to more similar levels. The bead and composition can be said to be density matched.

A variety of processes known in the art can be used to make the beads herein. Examples of processes for making microcapsule beads are described in U.S. Pat. Nos. 2,800,458; 3,159,585; 3,516,846; 3,516,941; 3,533,958; 3,697,437; 3,778,383; 3,888,689; 3,965,033; 3,996,156; 4,010,038; 4,016,098; 4,087,376; 4,089,802; 4,100,103; 4,251,386; 4,269,729; 4,303,548; 4,460,722; and 4,610,927; UK Patent Nos. 1,156,725; 1,483,542; 2,041,319 and 2,048,206; and Benita, Simon (ed.), MICROENCAPSULATION: METHODS AND INDUSTRIAL APPLICATIONS (Marcel Dekker, Inc. 1996). Preferably the microcapsules are prepared by a precipitation method whereby polymers in solution are precipitated around a hydrophobic core material, resulting in a clear, non-pigmented shell surrounding a single droplet or particle of core material. By contrast porous, sponge-like beads are prepared by an extrusion process and consist of many small droplets or particles trapped within a polymer matrix more like a sponge than a capsule. Said beads are available from Lipotechnologies.

Suitable ingredients that may be incorporated into the beads include any ingredient which is incompatible with the ingredients of another phase of the composition. Preferred ingredients for incorporation into the beads include perfume, enzyme, skin conditioning agent and bleach.

Any perfume suitable for perfuming the present composition or enzyme, described in more detail later, may be applied to or into the beads. By skin conditioning agent it is meant a component that improves the barrier health of the skin or provides a superficial skin benefit sensation. Agents providing an improvement in skin barrier health include moisturizers, e.g. oils, glycerin, which replenishes skin lipids, and bioactives that effectively feed the skin nutrients that promote skin health. Examples of bioactives include vitamins, particularly vitamin E and A and vitamin precursors, such as niacinamide.

Agents that provide a superficial benefit sensation to the skin include agents which cool or sooth the skin, but do not clearly aid skin barrier health. Examples include menthols and peppermint, Frescolat®, thymol.

Examples of preferred skin conditioning agents include algae, vitamins, Aloe vera and oils, such as sunflower, Aloe vera, grapeseed, jojoba.

Another preferred ingredient for incorporation into the beads is a bleach. Suitable bleaches include hydrophobic bleaches, preferably alkyl peracids and peroxides. The most preferred choice of bleach is a benzoyl peroxide.

### Surfactant

The composition of the present invention comprises at least 20%, more preferably at least 25% surfactant. Surfactants may be selected from the group consisting of amphoteric, zwitterionic, nonionic, anionic, cationic surfactants and mixtures thereof. A selection of preferred surfactants are described below, however it is envisaged that any known and suitable surfactant for the purpose may be employed in the compositions of the present invention.

Amphoteric surfactants are preferred surfactants. Specifically preferred amphoteric surfactants useful in the present invention are selected from amine oxide surfactants. Amine oxides are semi-polar nonionic surfactants and include water-soluble amine oxides containing one linear or branched alkyl moiety of from 10 to 18 carbon atoms and 2 moieties selected from the group consisting of alkyl groups and hydroxyalkyl groups containing from 1 to 3 carbon atoms; water-soluble phosphine oxides containing one alkyl moiety of from 10 to 18 carbon atoms and 2 moieties selected from the group consisting of alkyl groups and hydroxyalkyl groups containing from 1 to 3 carbon atoms; and water-soluble sulfoxides containing one alkyl moiety of from 10 to 18 carbon atoms and a moiety selected from the group consisting of alkyl and hydroxyalkyl moieties of from 1 to 3 carbon atoms.

Suitable nonionic detergent surfactants are generally disclosed in U.S. Pat. No. 3,929,678, Laughlin et al., issued Dec. 30, 1975, at column 13, line 14 through column 16, line 6, incorporated herein by reference. Preferred nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. This category of nonionic surfactant is referred to generally as “alkyl ethoxylates.”

Other suitable surfactants include alkylpolyglycosides, fatty acid or polyhydroxy fatty amide surfactants known in the art.

Other particularly preferred surfactants are anionic surfactants. Suitable anionic surfactants for use in the compositions herein include water-soluble salts or acids of the formula ROSO₃M wherein R preferably is a C₆-C₂₀ linear or branched hydrocarbyl, preferably an alkyl or hydroxyalkyl having a C₁₀-C₂₀ alkyl component, more preferably a C₁₀-C₁₄ alkyl or hydroxyalkyl, and M is H or a cation, e.g., an alkali metal cation or ammonium or substituted ammonium, but preferably sodium. Alkyl sulfates, alkyl ethoxylated sulfates and alkyl propoxylated sulfates are contemplated herein.

Other suitable anionic surfactants for use herein are alkyl sulphonates including water-soluble salts or acids of the formula RSO₃M wherein R is a C₆-C₂₀ linear or branched, saturated or unsaturated alkyl group, preferably a C₁₀-C₂₀ alkyl group and more preferably a C₁₀-C₁₄ alkyl group, and M is H or a cation, e.g., an alkali metal cation.

The particular surfactants used can therefore vary widely depending upon the particular end-use envisioned. Suitable additional surfactants are described in detail in the copending provisional patent application of Chandrika Kasturi et al., entitled “Liquid Detergent Compositions Comprising Polymeric Suds Enhancers”, having P & G Case No. 6938P, application serial No. 60/066,344, incorporated above. Preferably the composition comprises a surfactant selected from anionic, amphoteric, nonionic surfactants and mixtures thereof.

In a preferred embodiment, the present composition comprises at least 25% surfactant. In a further preferred embodiment the composition. In a further preferred embodiment the surfactant is a surfactant system consisting of at least 20% anionic surfactant, at least 4% amine oxide and at least 1% alkyl ethoxylated non-ionic surfactant.

### Structuring Agent

The present compositions preferably comprise a structuring agent. A structuring agent can be important to suspend the microcapsules in the composition to prevent the beads from settling out of solution. Thus a structuring agent can be important in achieving stable suspension of the beads.

The level and type of structuring agent is preferably selected to provide viscoelastic properties. The preferred structuring agents provide a weak gel formation matrix, in which polymeric or non-polymeric ingredients interact with each other and form hydrogen and/or hydrophobic bonding. Some functional groups on the molecules have electrostatic repulsive forces that can prevent coagulation of the particles in the composition. The weakly formed gel matrix resulting from the preferred structuring agents herein is capable of suspending the beads.

When present, structuring agents may be present at a level of from about 0.001% to about 10%, more preferably from about 0.005% to about 5%, even more preferably from about 0.01% to about 1% and most preferably from 0.01-0.01% by weight of the composition.

The structuring agents herein can be selected from materials or mixtures of polymeric gums, microbial polysaccharides and polysaccharide derivatives such as pectine, alginate, arabinogalactan, carageenan, gellan gum, xanthum gum, guar gum. Preferred structuring agents herein include those selected from the group consisting of gellan gum, guar gum, xanthan gum, and mixtures thereof.

Gellan gum is a heteropolysaccharide prepared by fermentation of Pseudomonaselodea ATCC 31461. Gellan gum is available from CP Kelco U.S., Inc. under various names, including KELCOGEL®, KELCOGEL® LT100, KELCOGEL® AFT, KELCOGEL® AF, KELCOGEL® PC, and KELCOGEL® F. Processes for preparing gellan gum are described in U.S. Pat. No. 4,326,052 (Kang et al), issued Apr. 20, 1982; U.S. Pat. No. 4,326,053 (Kang et al), issued Apr. 20, 1982; U.S. Pat. No. 4,377,636 (Kang et al), issued Mar. 22, 1983; and U.S. Pat. No. 4,385,123 (Kang et al), issued May 24, 1983.

### Optional Ingredients

The compositions of the present invention may also comprise optional ingredients for example diamine, additional surfactants, solvents, polymeric suds stabiliser, enzymes, builder, perfume, chelating agent and mixtures thereof.

All parts, percentages and ratios used herein are expressed as percent weight unless otherwise specified. All documents cited are, in relevant part, incorporated herein by reference.

### Solvent

The present compositions may preferably comprise a solvent. Suitable solvents include diols polymeric glycols and mixtures of both diols and polymeric glycols. Diols suitable for use in the present invention have the following formula:

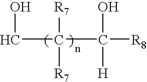

wherein n =0- 3, R₇=H, methyl or ethyl; and R₈=H, methyl, ethyl, propyl, isopropyl, butyl and isoubutyl. Preferred diols include propylene glycol, 1,2 hexanediol, 2-ethyl-1,3-hexanediol and 2,2,4-trimethyl-1,3-pentanediol. When diols are present, the present compositions will comprise at least 0.5%, more preferably at least 1%, even more preferably still, at least 3% by weight of the composition of diols. The composition will also preferably contain no more than 20%, more preferably no more than 10%, even more preferably, no more than 6% by weight of the composition of diols.

Polymeric glycols, which comprise ethylene oxide (EO) and propylene oxide (PO) groups may also be included in the present invention. These materials are formed by adding blocks of ethylene oxide moieties to the ends of polypropylene glycol chains. Polymeric gycols suitable for use in the present invention are of the following formula:

(PO)ₓ(EO)_{y}H

wherein x+y is from 17 to 68, and x/(x+y) is from 0.25 to 1.0. A preferred polymeric glycol is a polyproylene glycol (corresponding to when y≈0) having an average molecular weight of between 1000 to 5000, more preferably between 2000 to 4000, most preferably 2000 to 3000.

When polymeric glycols are present the present liquid detergent compositions will contain at least 0.25%, more preferably at least 0.5%, even more preferably still, at least 0.75% by weight of the composition of polymeric glycols. The composition will also preferably contain no more than 5%, more preferably no more than 3%, even more preferably, no more than 2% by weight of the composition.

To insure satisfactory physical stability, whenever polymeric glycols are added to a liquid dishwashing composition, it may be necessary to also include either a diol and/or an alkali metal inorganic salt, such as sodium chloride. Suitable amounts of diols to provide physical stability are in the amounts in the ranges found above, while a suitable amount of an alkali metal inorganic salt is at least 0.1% and less than 1.5%, preferably less than 0.8% by weight of the composition.

As discussed above, the addition of diols can improve the physical and enzymatic stability of a liquid dishwashing composition.

Other suitable solvents include lower alkanols, diols, other polyols, ethers, amines, and the like may be used in the present invention. Particularly preferred are the C1-C4 alkanols.

Other suitable solvents are glycols or alkoxylated glycols, ethers and diethers having from 4 to 14 carbon atoms, preferably from 6 to 12 carbon atoms, alkoxylated aromatic alcohols, aromatic alcohols, aliphatic branched alcohols, alkoxylated aliphatic branched alcohols, alkoxylated linear C1-C5 alcohols, linear C1-C5 alcohols, C8-C14 alkyl and cycloalkyl hydrocarbons and halohydrocarbons, C6-C16 glycol ethers and mixtures thereof. Suitable alkoxylated glycols are methoxy octadecanol and/or ethoxyethoxyethanol, a suitable aromatic alcohol is benzyl alcohol, suitable aliphatic branched alcohol are 2-ethylbutanol and/or 2-methylbutanol, suitable alkoxylated aliphatic branched alcohols include 1-methylpropoxyethanol and/or 2-methylbutoxyethanol and suitable linear C₁-C₅ alcohols are methanol, ethanol, propanol or mixtures thereof.

Other suitable solvents include, but are not limited to, butyl diglycol ether (BDGE), butyltriglycol ether, ter amilic alcohol and the like.

Besides propylene glycol,polypropylene glycol and the diols illustrated above, other glycols according to the formula: HO-CR1R2-OH wherein R1 and R2 are independently H or a C2-C10 saturated or unsaturated aliphatic hydrocarbon chain and/or cyclic are suitable and can be used herein. One such suitable glycol is dodecaneglycol.

Other suitable solvents for use herein include propylene glycol derivatives such as n-butoxypropanol or n-butoxypropoxypropanol, water-soluble CARBITOL R solvents or water-soluble CELLOSOLVE R solvents; water-soluble CARBITOL R solvents are compounds of the 2-(2-alkoxyethoxy)ethanol class wherein the alkoxy group is derived from ethyl, propyl or butyl; a preferred water-soluble carbitol is 2-(2-butoxyethoxy)ethanol also known as butyl carbitol. Water-soluble CELLOSOLVE R solvents are compounds of the 2-alkoxyethoxy ethanol class, with 2-butoxyethoxyethanol being preferred. Other suitable solvents include benzyl alcohol, and diols such as 2-ethyl-1, 3-hexanediol and 2,2,4-trimethyl-1,3-pentanediol and mixtures thereof. Some preferred solvents for use herein are n-butoxypropoxypropanol, BUTYL CARBITOL Ò and mixtures thereof.

The solvents can also be selected from the group of compounds comprising ether derivatives of mono-, di- and tri-ethylene glycol, butylene glycol ethers, and mixtures thereof. The molecular weights of these solvents are preferably less than 350, more preferably between 100 and 300, even more preferably between 115 and 250. Examples of preferred solvents include, for example, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename “Dowanol” and from the Arco Chemical Company under the tradename “Arcosolv”. Other preferred solvents including mono- and di-ethylene glycol n-hexyl ether are available from the Union Carbide company.

When present the composition will preferably contain at least 0.01%, more preferably at least 0.5%, even more preferably still, at least 1% by weight of the composition of solvent. The composition will also preferably contain no more than 20%, more preferably no more than 10%, even more preferably, no more than 8% by weight of the composition of solvent.

These solvents may be used in conjunction with an aqueous liquid carrier, such as water, or they may be used without any aqueous liquid carrier being present. Solvents are broadly defined as compounds that are liquid at temperatures of 20° C.-25° C. and which are not considered to be surfactants. One of the distinguishing features is that solvents tend to exist as discrete entities rather than as broad mixtures of compounds.

### Diamines

Another optional although preferred ingredient of the compositions according to the present invention is a diamine. In the context of a hand dishwashing composition, the “usage levels” of such diamine in the compositions herein can vary depending not only on the type and severity of the soils and stains, but also on the wash water temperature, the volume of wash water and the length of time the dishware is contacted with the wash water.

Since the habits and practices of the users of detergent compositions show considerable variation, the composition will preferably contain at least 0.1%, more preferably at least 0.2%, even more preferably, at least 0.25%, even more preferably still, at least 0.5% by weight of said composition of diarnine. The composition will also preferably contain no more than 15%, more preferably no more than 10%, even more preferably, no more than 6%, even more preferably, no more than 5%, even more preferably still, no more than about 1.5% by weight of said composition of diamine.

It is preferred that the diamines used in the present invention are substantially free from impurities. That is, by “substantially free” it is meant that the diarnines are over 95% pure, i.e., preferably 97%, more preferably 99%, still more preferably 99.5%, free of impurities. Examples of impurities which may be present in commercially supplied diamines include 2-Methyl-1,3-diaminobutane and alkylhydropyrimidine. Further, it is believed that the diamines should be free of oxidation reactants to avoid diamine degradation and ammonia formation.

Preferred organic diamines are those in which pK1 and pK2 are in the range of 8.0 to 11.5, preferably in the range of 8.4 to 11, even more preferably from 8.6 to 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2—As used herein, “pKa1” and “pKa2” are quantities of a type collectively known to those skilled in the art as “pKa”. pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diarnunes.

As a working definition herein, the pKa of the diamines is specified in an all-aqueous solution at 25° C. and for an ionic strength between 0.1 to 0.5 M. The pKa is an equilibrium constant which can change with temperature and ionic strength; thus, values reported in the literature are sometimes not in agreement depending on the measurement method and conditions. To eliminate ambiguity, the relevant conditions and/or references used for pKa's of this invention are as defined herein or in “Critical Stability Constants: Volume 2, Amines”. One typical method of measurement is the potentiometric titration of the acid with sodium hydroxide and determination of the pKa by suitable methods as described and referenced in “The Chemist's Ready Reference Handbook” by Shugar and Dean, McGraw Hill, N.Y., 1990.

It has been determined that substituents and structural modifications that lower pK1 and pK2 to below 8.0 are undesirable and cause losses in performance. This can include substitutions that lead to ethoxylated diamines, hydroxy ethyl substituted diamines, diamines with oxygen in the beta (and less so gamma) position to the nitrogen in the spacer group (e.g., Jeffamine EDR 148). In addition, materials based on ethylene diamine are unsuitable.

The diamines useful herein can be defined by the following structure:

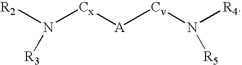

wherein R₂₋₅ are independently selected from H, methyl, —CH₃CH₂, and ethylene oxides; C_{X} and C_{V} are independently selected from methylene groups or branched alkyl groups where x+y is from 3 to 6; and A is optionally present and is selected from electron donating or withdrawing moieties chosen to adjust the diamine pKa's to the desired range. If A is present, then x and y must both be 1 or greater.

Examples of preferred diamines can be found in the copending provisional patent application of Phillip Kyle Vinson et al., entitled “Dishwashing Detergent Compositions Containing Organic Diamines for Improved Grease Cleaning, Sudsing, Low Temperature Stability and Dissolution”, having P & G Case No. 7167P, application serial No. 60/087,693, and filed on Jun. 2, 1998, which is hereby incorporated by reference.

### Carboxylic Acid

The compositions according to the present invention may comprise a linear or cyclic carboxylic acid or salt thereof. Where the acid or salt thereof is present and is linear, it preferably comprises from 1 to 6 carbon atoms whereas where the acid is cyclic, it preferably comprises greater than 3 carbon atoms. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms and mixtures thereof

The carboxylic acids or salts thereof preferably have a pKa1 of less than 7, more preferably from 1 to 3. The carboxylic acid and salts thereof may comprise one or two or more carboxylic groups.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2, 4 benzene tricarboxylic acid, pentanoic acid and salts thereof and mixtures thereof. Where the carboxylic acid exists in the salt form, the cation of the salt is preferably selected from alkali metal, alkaline earth metal, monoethanolamine, diethanolamine or triethanolamine and mixtures thereof.

The carboxylic acid or salt thereof is preferably present at the level of from 0.1% to 5%, more preferably from 0.2% to 1% and most preferably from 0.25% to 0.5%.

### Polymeric Suds Stabilizer

The compositions of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from:

i) homopolymers of (N,N-dialkylamino)alkyl acrylate esters having the formula:

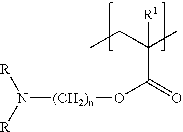

wherein each R is independently hydrogen, C₁-C₈ alkyl, and mixtures thereof, R¹ is hydrogen, C₁-C₆ alkyl, and mixtures thereof, n is from 2 to 6; and

ii) copolymers of (i) and

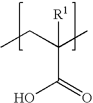

wherein R¹ is hydrogen, C1-C6 alkyl, and mixtures thereof, provided that the ratio of (ii) to (i) is from 2 to 1 to 1 to 2; The molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely

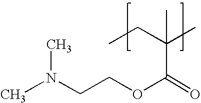

When present in the compositions, the polymeric suds booster may be present in the composition from 0.01% to 15%, preferably from 0.05% to 10%, more preferably from 0.1% to 5%, by weight.

### Builder

The compositions according to the present invention may further comprise a builder system. Because builders such as citric acid and citrates impair the stability of enzymes, it is desirable to include reduce the amounts or completely remove the builder salts normally utilized in LDL compositions incorporating propylene glycol as a builder. When a detergent composition includes propylene glycol solvent as a part or a whole of the detergent's carrier, enzymes are more stable and smaller amounts or no builder salts are needed.

If it is desirable to use a builder, then any conventional builder system is suitable for use herein including aluminosilicate materials, silicates, polycarboxylates and fatty acids, materials such as ethylene-diamine tetraacetate, metal ion sequestrants such as aminopolyphosphonates, particularly ethylenediamine tetramethylene phosphonic acid and diethylene triamine pentamethylene-phosphonic phosphonic acid. Though less preferred for obvious environmental reasons, phosphate builders can also be used herein.

Suitable polycarboxylates builders for use herein include citric acid, preferably in the form of a water-soluble salt, derivatives of succinic acid of the formula R—CH(COOH)CH₂(COOH) wherein R is C₁₀₋₂₀ alkyl or alkenyl, preferably C₁₂₋₁₆, or wherein R can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Especially for the liquid execution herein, suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they will be included in amounts of from 0.5% to 50% by weight of the composition preferably from 5% to 30% and most usually from 5% to 25% by weight.

### Enzymes

Detergent compositions of the present invention may further comprise one or more enzymes which provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof. A preferred combination is a detergent composition having a cocktail of conventional applicable enzymes like protease, amylase, lipase, cutinase and/or cellulase. Enzymes when present in the compositions, at from 0.0001% to 5% of active enzyme by weight of the detergent composition. Preferred proteolytic enzymes, then, are selected from the group consisting of Alcalase® (Novo Industri A/S), BPN′, Protease A and Protease B (Genencor), and mixtures thereof. Protease B is most preferred. Preferred amylase enzymes include TERMAMYL®, DURAMYL® and the amylase enzymes those described in WO 9418314 to Genencor International and WO 9402597 to Novo.

Further non-limiting examples of suitable and preferred enzymes are disclosed in the copending application: “Dishwashing Detergent Compositions Containing Organic Diamines for Improved Grease Cleaning, Sudsing, Low temperature stability and Dissolution”, having P & G Case No. 7167P and application serial No. 60/087,693, which is hereby incorporated by reference.

Because hydrogen peroxide and builders such as citric acid and citrates impair the stability of enzymes in LDL compositions, it is desirable to reduce or eliminate the levels of these compounds in compositions which contain enzymes. Hydrogen peroxide is often found as an impurity in surfactants and surfactant pastes. As such, the preferred level of hydrogen peroxide in the amine oxide or surfactant paste of amine oxide is 0-40 ppm, more preferably 0-15 ppm. Amine impurities in amine oxide and betaines, if present, should be minimized to the levels referred above for hydrogen peroxide.

### Magnesium Ions

While it is preferred that divalent ions be omitted from compositions prepared according to the present invention, alternate embodiments of the present invention may include magnesium ions.

If they are to be included in an embodiment of the present compositions, then the magnesium ions are present at an active level of from 0.01% to 1.5%, preferably from 0.015% to 1%, more preferably from 0.025% to 0.5%, by weight.

Preferably, the magnesium ions are added as a hydroxide, chloride, acetate, sulfate, formate, oxide or nitrate salt to the compositions of the present invention. Because during storage, the stability of these compositions becomes poor due to the formation of hydroxide precipitates in the presence of compositions containing moderate concentrations of hydroxide ions, it may be necessary to add certain chelating agents. Suitable chelating agents are discussed further below and in U.S. Pat. No. 5,739,092, issued Apr. 14, 1998, to Ofosu-asante, incorporated herein by reference.

### Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylenediaminetetrace-tates, N-hydroxyethylethylenediaminetriacetates, nitrilo-tri-acetates, ethylenediamine tetrapro-prionates, triethylenetetraaminehexacetates, diethylenetriaminepentaacetates, and ethanoldi-glycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylenediaminetetrakis (methylenephosphonates) as DEQUEST. Preferred, these amino phosphonates to not contain alkyl or alkenyl groups with more than 6 carbon atoms.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelator for use herein is ethylenediamine disuccinate (“EDDS”), especially the [S,S] isomer as described in U.S. Pat. No. 4,704,233, Nov. 3, 1987, to Hartman and Perkins.

The compositions herein may also contain water-soluble methyl glycine diacetic acid (MGDA) salts (or acid form) as a chelant or co-builder. Similarly, the so-called “weak” builders such as citrate can also be used as chelating agents.

If utilized, these chelating agents will generally comprise from 0.00015% to 15% by weight of the detergent compositions herein. More preferably, if utilized, the chelating agents will comprise from 0.0003% to 3.0% by weight of such compositions.

Other Ingredients—The detergent compositions will further preferably comprise one or more detersive adjuncts selected from the following: soil release polymers, polysaccharides, abrasives, bactericides and other antimicrobials, tarnish inhibitors, builders, enzymes, dyes, buffers, antifungal or mildew control agents, insect repellents, perfumes, hydrotropes, thickeners, processing aids, suds boosters, brighteners, anti-corrosive aids, stabilizers antioxidants and chelants. A wide variety of other ingredients useful in detergent compositions can be included in the compositions herein, including other active ingredients, carriers, hydrotropes, antioxidants, processing aids, dyes or pigments, solvents for liquid formulations, solid fillers for bar compositions, etc. If high sudsing is desired, suds boosters such as the C₁₀-C₁₆ alkanolamides can be incorporated into the compositions, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous.

An antioxidant can be optionally added to the detergent compositions of the present invention. They can be any conventional antioxidant used in detergent compositions, such as 2,6-di-tert-butyl-4-methylphenol (BHT), carbamate, ascorbate, thiosulfate, monoethanolamine(MEA), diethanolamine, triethanolamine, etc. It is preferred that the antioxidant, when present, be present in the composition from 0.001% to 5% by weight.

Various detersive ingredients employed in the present compositions optionally can be further stabilized by absorbing said ingredients onto a porous hydrophobic substrate, then coating said substrate with a hydrophobic coating. Preferably, the detersive ingredient is admixed with a surfactant before being absorbed into the porous substrate. In use, the detersive ingredient is released from the substrate into the aqueous washing liquor, where it performs its intended detersive function.

To illustrate this technique in more detail, a porous hydrophobic silica (trademark SIPERNAT D10, DeGussa) is admixed with a proteolytic enzyme solution containing 3%-5% of C₁₃₋₁₅ ethoxylated alcohol (EO 7) nonionic surfactant. Typically, the enzyme/surfactant solution is 2.5× the weight of silica. The resulting powder is dispersed with stirring in silicone oil (various silicone oil viscosities in the range of 500-12,500 can be used). The resulting silicone oil dispersion is emulsified or otherwise added to the final detergent matrix. By this means, ingredients such as the aforementioned enzymes, bleaches, bleach activators, bleach catalysts, photoactivators, dyes, fluorescers, fabric conditioners and hydrolyzable surfactants can be “protected” for use in detergents, including liquid laundry detergent compositions.

Further, these hand dishwashing detergent embodiments preferably further comprises a hydrotrope. Suitable hydrotropes include sodium, potassium, ammonium or water-soluble substituted ammonium salts of toluene sulfonic acid, naphthalene sulfonic acid, cumene sulfonic acid, xylene sulfonic acid.

### Non-Aqueous Liquid Detergents

The manufacture of liquid detergent compositions which comprise a non-aqueous carrier medium can be prepared according to the disclosures of U.S. Pat. Nos. 4,753,570; 4,767,558; 4,772,413; 4,889,652; 4,892,673; GB-A-2,158,838; GB-A-2,195,125; GB-A-2,195,649; U.S. Pat. No. 4,988,462; U.S. Pat. No. 5,266,233; EP-A-225,654 (Jun. 16, 1987); EP-A-510,762 (Oct. 28, 1992); EP-A-540,089 (May 5, 1993); EP-A-540,090 (May 5, 1993); U.S. Pat. No. 4,615,820; EP-A-565,017 (Oct. 13, 1993); EP-A-030,096 (Jun. 10, 1981), incorporated herein by reference. Such compositions can contain various particulate detersive ingredients stably suspended therein. Such non-aqueous compositions thus comprise a LIQUID PHASE and, optionally but preferably, a SOLID PHASE, all as described in more detail hereinafter and in the cited references.

### Process of Cleaning Dishware

The dishware is contacted with a composition as described above. The composition may be applied to the dishware neat or in dilute form. Thus the dishware may be cleaned singly by applying the composition to the dishware or the cleaning implement e.g. sponge or cloth, and optionally, but preferably, subsequently rinsing before drying. Alternatively, the composition can be mixed with water in a suitable vessel, for example a basin, sink or bowl and thus a number of dishes can be cleaned using the same composition and water (dishwater). In a further alternative process the product can be used in dilute form in a suitable vessel as a soaking medium for, typically extremely dirty, dishware. As before the dishware can be optionally, although preferably, rinsed before allowing to dry. Drying make take place passively by allowing for the natural evaporation of water or actively using any suitable drying equipment, for example a cloth or towel.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

What is claimed is:

1. A composition, suitable for use as a manual dishwashing composition, comprising stably suspended beads and at least about 20% surfactant and exhibiting dissolution in water in less than 10 rotations according to the cylinder dissolution test described herein.

2. A composition according to claim 1 wherein the composition contains less than about 1% of a structuring agents including polymers and polymer gums and combinations thereof.

3. A composition according to claim 1 wherein the composition has about 75% or greater transmittance of light using a 1 cm cuvette at at least one wavelength in the range from 410-800 nm, in the absence of dyes and beads.

4. A composition according to claim 1 wherein the composition at 100% composition concentration has viscosity of about 100-2000 cps.

5. A composition according to claim 1 comprising at least about 25% surfactant.

6. A composition according to claim 1 wherein the surfactant is selected from anionic, non-ionic, amphoteric surfactants, and mixtures thereof.

7. A composition according to claim 1 wherein the surfactant is a surfactant system consisting of at least about 20% anionic surfactant, at least about 4% amine oxide and at least about 1% alkyl ethoxylated non-ionic surfactant.

8. A composition according to claim 1 comprising beads made from materials selected from agar, gelatin, polyoxymethylene urea, methophenols and mixtures thereof.

9. A composition according to claim 1 wherein the beads are selected from porous beads.

10. A composition according to claim 1 wherein the beads comprise an active ingredient selected from bleach, enzyme, perfume, skin conditioning agent and mixtures thereof.

11. A composition according to claim 1 comprising a structuring agent selected from polymeric gums, microbial polysaccharides and polysaccharide derivatives such as pectine, alginate, arabinogalactan, carageenan, gellan gum, xanthum gum, guar gum and mixtures thereof.

12. A composition according to claim 11 wherein the structuring agent is gellan gum.

13. A composition according to claim 1 exhibiting dissolution in water in less than 8 rotations of the cylinder test described herein.

14. A process of cleaning dishware using the composition according to claim 1.

15. A process according to claim 14 comprising the steps of applying the composition to a cleaning implement, the cleaning implement being moistened before and/or after application of the composition.
